(19) United States
(12) Patent Application Publication
(10) Pub. No.: US 2009/0183195 A1
(43) Pub. Date: Jul. 16, 2009

(54) Regulatory Environment Adaptation Layer for Content Protection

(75) Inventor: Jukka Alve, Vantaa (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/972,172

(22) Filed: Jan. 10, 2008

(51) Int. Cl. H04N 7/16; H04N 7/173

(52) U.S. Cl. 725/25; 725/131

(57) ABSTRACT

Aspects of the invention provide apparatuses, computer media, and methods for supporting post-delivery content protection systems, which are used to protect the content of free-to-air (FTA) or clear-to-air (CTA) digital broadcasts after reception against unauthorized use such as Internet redistribution. A receiver circuit of a receiver device obtains a broadcast stream, which contains usage restriction signaling and content. A regulatory determination circuit obtains regulations for the distribution of the content from a regulation database system based on an apparatus parameter such as the country that the receiver device is located. The regulatory determination circuit further obtains the usage state of the content from the regulations and usage restriction signaling by mapping each signaling state to a usage state. The content at the acquisition point is protected in accordance with the usage state.

### FIELD OF THE INVENTION

The present invention relates to providing content protection to broadcast content.

### BACKGROUND

In an effort to combat unauthorized content redistribution and other unauthorized usage, content providers are increasingly demanding technical measures for protecting electronically distributed content, including digital television broadcasts. Pay-TV services have already been protected by various Conditional Access systems against unauthorized access for years. More recently, the focus has shifted to protecting content against unauthorized usage throughout its lifecycle, also after it has been received by the authorized recipient, in order to prevent for instance the unauthorized redistribution of the content to others over the Internet. This has raised requests that also free-to-air broadcast content should have similar post-delivery protection, even though the broadcast signal itself may not be encrypted or scrambled.

Moreover, regulations for the broadcasting, distribution and redistribution of content often vary by country. Electronic distribution of content (particularly digital TV content) is typically done with country-specific variants of hardware or software products, which may be costly for manufacturers because the economy of scale is lost. Furthermore, since regulations often change over time, the country-specific variants may need to be updated from time to time, increasing the complexity of version management even further.

Thus, there is a real market need to distribute content in an effective manner in accordance with distribution regulations that may change with time across different jurisdictions.

### SUMMARY

An aspect provides apparatuses, computer-readable media, and methods for supporting post-delivery content protection systems, which are used to protect the content of free-to-air (FTA) or clear-to-air (CTA) digital broadcasts after reception against unauthorized use such as Internet redistribution.

With another aspect, a receiver module of a receiver device obtains one or more broadcast streams, which contain usage restriction signaling and/or content. A regulatory determination module determines the regulations for the distribution of the content from an apparatus parameter associated with the receiver device. The regulatory determination module further obtains the usage state of the content from the regulations and usage restriction signaling by mapping each signaling state to a usage state. The content at the acquisition point is protected in accordance with the usage state.

With another aspect, the usage restriction signaling is contained in service information signaling of a digital video broadcasting (DVB) transport stream.

With another aspect, parameters used for determining pertinent regulations include the current location of the receiver module. The current location may be determined for example from the broadcast cell ID, cellular telephone network cell ID, currently allocated IP address, or global positioning system (GPS). In one aspect the receiver module may determine the current location from an adjacent connected device capable of location determination. The current location may correspond to the country in which the receiver device is located.

With another aspect, regulatory information is updated in cache memory of a receiver device when updates are obtained from a regulation database system. Consequently, the regulation database system need not be queried each time content is being evaluated regarding protection.

With another aspect, regulatory updates are obtained by a receiver device from a broadcast stream. The updates may be pushed from a regulation database system over a communications channel to the broadcaster.

With another aspect, a regulation database system stores regulatory information in a storage device and provides the regulatory information when queried by a receiver device. The regulatory information contains a mapping from each signaling state to a corresponding usage state of a content protection system.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows an exemplary digital video broadcasting (DVB) content protection and copy management (CPCM) authorized domain in accordance with an embodiment of the invention.

FIG. 2 shows an architecture of an apparatus that supports a regulatory environment adaptation layer (REAL) in accordance with an embodiment of the invention.

FIG. 3 shows a flow diagram for processing content received over a broadcast stream in accordance with an embodiment of the invention.

FIG. 4 shows a process for updating regulatory information in accordance with an embodiment of the invention.

FIG. 5 shows a flow diagram for processing content received over a broadcast stream in accordance with an embodiment of the invention.

FIG. 6 shows an architecture of an apparatus that receives content from a broadcast stream in accordance with an embodiment of the invention.

FIG. 7 shows an architecture of a storage system that provides regulatory information in accordance with an embodiment of the invention.

### DETAILED DESCRIPTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

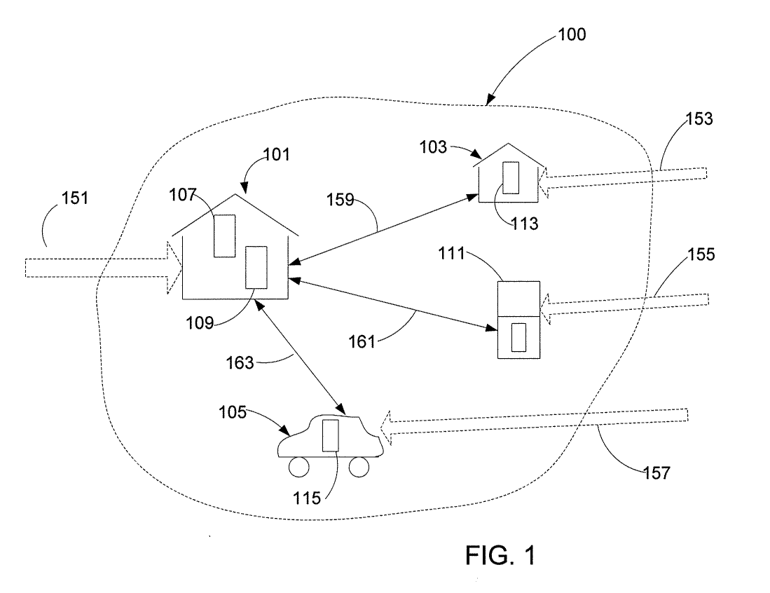

FIG. 1 shows an exemplary digital video broadcasting (DVB) content protection and copy management (CPCM) authorized domain 100 in accordance with an embodiment of the invention. Domain 100 encompasses devices 107 and 109, which are shown as being located in a user's primary house 101, device 113, which is located in user's secondary house 103, device 115, which is located in automobile 105, and device 111. While device 111 is shown as being separate from primary house 101, secondary house 103, and automobile 105, device 111 is portable and may reside in or outside of entities 101-105. Devices 107-115 may be networked together in domain 100 through communication channels 159, 161 and 163.

DVB-CPCM is a system for content protection and copy management of commercial digital content (e.g., television shows) delivered to the consumer's receiver device.

CPCM manages content usage from acquisition into the CPCM system (corresponding to domain 100) until final consumption or export from the CPCM system, in accordance with the particular usage rules of that content. DVB CPCM specifications have been published in the DVB Blue Book A094r1, which is available at the website http://www.dvb.org/technology/dvb-cpcm/index.xml. Each device receives content over broadcast streams 151, 153, 155, and 157, corresponding to primary house 101, secondary house 105, portable device 111, and automobile 105, respectively. With a DVB-CPCM system, a broadcast channel is typically implemented as a transport stream that contains a plurality of elementary streams. A service is associated with one or more elementary streams. Each service supports events, e.g., a TV show.

With embodiments of the invention, broadcast channels 151-153 may be implemented with wireline, cable, or wireless facilities. Because of the portable characteristics of devices 111 and 115, broadcast streams 155-157 are typically supported by wireless facilities. Possible sources for commercial digital content include broadcast (e.g., cable, satellite, and terrestrial), cellular mobile networks, internet-based services, packaged media, and mobile services. CPCM is intended for use in protecting all types of content, including audio, video and associated applications, and data. CPCM provides specifications to facilitate interoperability of such content by networked consumer devices for both home networking and remote access.

CPCM is concerned with content after it has been acquired and does not concern itself with accessing the content, e.g., CA (Conditional Access) or DRM (Digital Rights Management) that protects the content on its way to the consumer. The fundamental boundaries of control within CPCM are the local environment and the authorized domain 100. Authorized domain 100 is defined as a distinguishable set of DVB-CPCM compliant devices (e.g., 107-115 as shown in FIG. 1), which may be owned, rented or otherwise controlled by members of a single household. Content is bound to its usage state information (USI), which describes how the content can be consumed, copied or exported relative to authorized domain 100 and the local environment. Compliant devices in authorized domain 100 can exchange content in accordance with the usage state information associated with the content.

Content that is delivered to a CPCM system may be either free-to-air (FTA) or clear-to-air (CTA). In both cases, access is granted but limited to a particular geographical location when FTA content is delivered in scrambled form. FTA content that has been protected for delivery can remain protected. When content is broadcast with clear-to-air, the content is sent in the clear (unscrambled). Content can remain in the clear after geographical delivery unless otherwise instructed through proper DVB free-to-air signaling information.

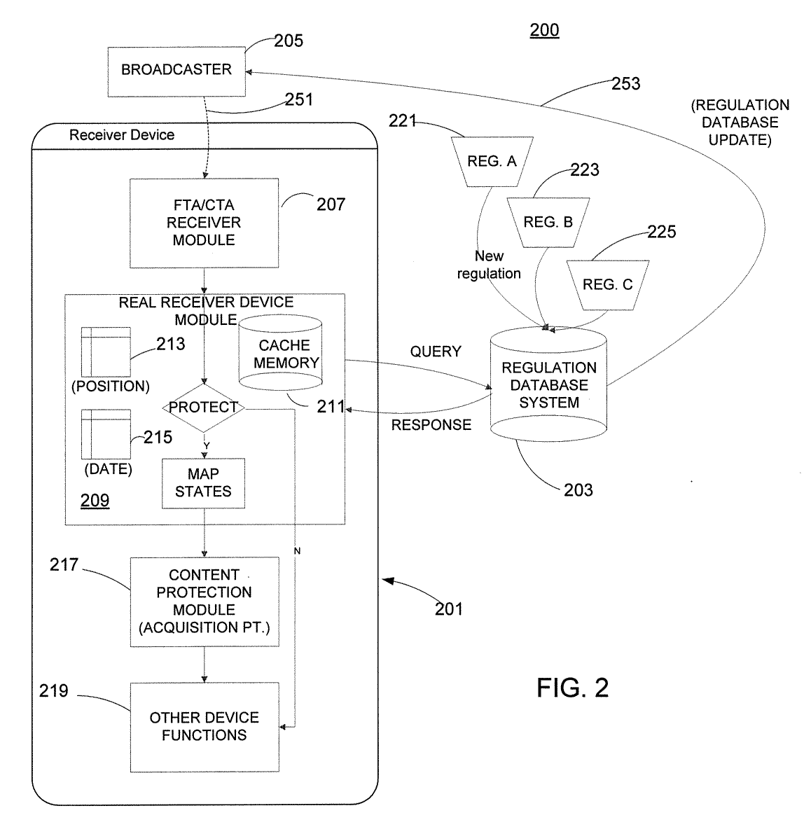

FIG. 2 shows architecture 200 of an apparatus that supports a regulatory environment adaptation layer (REAL), as supported by receiver device module (circuit) 209, in accordance with an embodiment of the invention. Architecture 200 enables a single product for the global market supporting country-specific variations in the regulations in a dynamic manner. In an attempt to prevent widespread unauthorized content redistribution by consumers, content providers may be eager to deploy technology that can be used to control what users can do with FTA/CTA broadcast content after reception, particularly the ability to redistribute the content over the Internet, but possibly also the ability to make copies or transfer high-definition signals over analog interfaces. The embodiment shown in FIG. 2 may support content protection technology in accordance with digital video broadcasting content protection and copy management (DVB-CPCM) as specified by CPCM DVB Document A094 Rev. 1, July 2007, accessible at http://www.dvb.org/technology/dvb-cpcm/index.xml.

Device manufacturers may be reluctant to implement the technology if the technology limits the functionality of the devices and thus reduces the appeal to consumers, particularly if a limitation sets them at a disadvantage on the market compared to competitors that have not implemented the technology. On the other hand, the same manufacturer may be interested in implementing the same content protection technology in its products for other reasons, e.g., to protect content originally delivered protected with conditional access systems and digital rights management systems.

Legislators or other regulatory bodies in some regulatory areas, e.g. countries, may adopt regulations that require manufacturers to implement FTA/CTA content protection systems, while in other regions or countries they may not. Furthermore, the schedule of adopting such regulations may vary from one country to another, while some countries may have exceptional rules regarding some kinds of usage restrictions. Consequently, the mapping from the signaled usage restrictions to the usage states enforced by the content protection technology may change from country to country. However, broadcasters whose signal can be received in multiple countries may wish to send the same transport stream to all those countries. For instance, if the broadcast is being transmitted over a satellite, the reception area may be very large compared to the area that a particular regulator has jurisdiction over. This characteristic creates a challenging situation for the manufacturer that wants to sell its products globally but doesn't want to adopt the FTA/CTA content protection technology any sooner than it is mandatory in a particular country and doesn't want to restrict the content usage any more than is required in a particular country. Receiver device module 209, which supports the regulatory environment adaptation layer between receiver module 207 and the DVB CPCM acquisition point as supported by content protection module 217, addresses the above concerns. A DVB CPCM acquisition point is defined where content enters a content protection system.

In one embodiment, the regulatory environment adaptation layer comprises two parts.

First, receiver device module 20 9, which is implemented in receiver device 201, is capable of receiving the FTA/CTA broadcast signal from broadcaster 205 over transport stream 251. Second, regulation database system 203, which is typically located at secure premises, is accessible for example through the Internet and/or through mobile cellular network and maintained by the device manufacturer or a compliance and robustness regime. Regulation database system 203 may receive regulatory information from regulators or regulatory bodies 221-225 corresponding to different countries.

Receiver device module 209 extracts FTA/CTA usage restriction signals from transport stream 251 which in one embodiment may be contained in Service Information (SI) in DVB broadcasts. Receiver device module 209 also securely stores apparatus parameters including such as the country where the device was sold, the date it was sold or first taken into use as stored in data structure 215, and the country or other regulatory region that device 201 is currently physically located as stored in data structure 213. The location of device 201 may be determined in a number of different ways, e.g., determined from a broadcast cell ID of the broadcast it is currently receiving, a cellular telephone network cell ID, a currently allocated IP address if it can be considered secure, or a global positioning system (GPS). In one embodiment the device may determine its current location from an adjacent connected device capable of location determination.

Receiver device module 209 also queries (e.g., over the Internet or other suitable network such as a mobile cellular network) regulation database system 203 containing the current regulations applicable to that country, determines whether the content needs to enter the content protection system or whether the content is allowed to remain unprotected, and what kind of translation or mapping of the FTA/CTA usage restriction signaling is applicable to the particular content protection system implemented on the device 201. One possible implementation is that from the rich set of Usage States supported by DVB CPCM Usage State Information, some states that are considered particularly relevant for FTA/CTA applications are selected for the small set of FTA/CTA signaling states. The bits representing the FTA/CTA signaling state that is applicable to a particular service or event will be carried in the Service Information for the service or event (e.g. “TV channel” or “TV program”). Upon acquisition of the content to DVB CPCM, the FTA/CTA signaling states are converted to DVB CPCM Usage States by looking up the corresponding DVB CPCM Usage States from a static table. One aspect of the invention is to make this mapping dynamic to support time variant regulations and to take into account country-specific variations in the regulations. Embodiments of the invention may obtain regulatory information for a set of countries and/or regions and select pertinent regulatory information for the area in which receiver device 201 is located. Alternatively, receiver device may specify the currently located country or region in the query request and receive regulatory information for only that country or region.

The FTA/CTA usage restriction signaling that may comprise a small number of bits will be carried in a new descriptor that may be called FTA_content_management_descriptor or FTA_content_redistribution_descriptor, or something similar and that could be added to a future version of ETSI EN 300 468 Digital Video Broadcasting (DVB); Specification for Service Information (SI) in DVB systems. The said descriptor can be added to network information table (NIT), service description table (SDT) and/or event information table (EIT). By utilizing the NIT, usage restriction signaling applies to the entire transport stream 251 containing a number of different programs (i.e., TV channels). By utilizing the SDT, a program-specific override is supported, while an event-specific override is supported with the EIT.

To reduce the need to communicate with the regulation database system 203 too often which may result in performance degradations, the results of the queries may be cached in cache memory 211 for a predetermined period, e.g., a week or a month.

With some embodiments of the invention, regulation database system 203 may be considered fairly static. In such cases, regulatory information may be stored locally in device 201 at the time of manufacture. Updates can be pushed by regulation database system 203 through communications channel 253 to device 201 over transport stream 251 whenever changes occur in collaboration with the broadcaster 205. This approach enables devices that don't have Internet connectivity to respond to changes in the regulation database system 203.

With some embodiments, updates, including additions and/or deletions and/or changes to the regulation database system 201, are transmitted using notifications and notification services. In this way, the coming updates may be distributed in advance by including data that disclose when the update(s) enter into force.

In other embodiments, FTA/CTA usage restriction signaling is tagged with a country code that identifies the country that the particular restriction applies to. However, this approach may require a modification in DVB SI signaling standard ETSI EN 300 468, so that multiple usage restriction descriptors may be attached to the same transport stream.

Each descriptor includes a country tag or tags that receiver device module 209 can use to determine whether that restriction applies to the content depending on the country that it is currently located in. In different embodiments, the country tag can be a single country code, for instance expressed with the ISO 3166 Alpha-3 syntax as used elsewhere in DVB SI or Alpha-2 syntax as used in DVB CPCM for the specification of Geographically constrained Authorized Domain (GAD), or a numeric code; alternatively a list of multiple country codes could be used, or, advantageously, a list of included country codes minus excluded country codes. By adding the definition AA=the entire world to the ISO 3166 2-character country codes, it is fairly easy to express, for instance, that a certain mapping applies to the entire world except, for instance, to Great Britain, by including AA in the list of included country codes, and GB in the list of excluded country codes.

A downside of the approach of sending multiple FTA/CTA usage control descriptors each tagged with a country code or country codes is that it consumes more bandwidth, therefore counteracting the idea behind using a short code consisting of only a few bits for expressing the most relevant DVB CPCM Usage States in FTA/CTA applications. A more efficient embodiment is to send the FTA/CTA usage control bits just once, but modify their exact meaning (i.e. the mapping to DVB CPCM Usage States) depending on the applicable regulations in the country where the receiver device is currently located.

In an exemplary implementation, regulation database system 203 may include one or more records that specify the country or countries that the regulation is applicable to, the validity period of the regulation, and a mapping from each of the FTA/CTA signalling states to the corresponding usage state of DVB CPCM. For instance, a record in the regulation database may indicate that starting from 1 Jan. 2010, the default mapping as specified in DVB CPCM shall be used in all European Union countries. Such a record would have a list of all the EU countries in the country tag, starting date set to 1 Jan. 2010, ending date set to not available (N/A), and for each of the possible states of the FTA/CTA signalling bits an entry that defines the corresponding DVB CPCM Usage State. Another record in the regulation database could indicate that in Great Britain, starting from 1 Jan. 2009 a mapping that further applies a resolution constraint on analogue interfaces to all content that has one of the FTA/CTA signalling bits for example bit B0 set. This record would have the country tag set to GB, starting date set to 1 Jan. 2009, ending date set to N/A, and for each of the possible states of the FTA/CTA signalling bits an entry that defines the corresponding DVB CPCM Usage State, with the resolution constraint of the Usage State Information set in those entries that have the said one signalling bit B0 set. If it were intended that the EU regulation overrules the GB regulation, the ending date would be set to 1 Jan. 2010 instead of N/A. If originally the ending date is not known, but eventually regulators in GB and EU reach an agreement on harmonizing the regulations by 1 Jun. 2010, this ending date can be updated to the database.

Note that in the examples above, a semantically neutral name B0 was used for the FTA/CTA signalling bit, because the semantics vary depending on the applicable regulations. Due to legacy reasons, the FTA/CTA signalling specifications may use more descriptive names for the bits, but if the invention is deployed, the bits can be relabelled with semantically neutral names.

Thus, device 201, which supports DVB CPCM, is able to determine that device 201 is in a specific country (e.g., Great Britain) and knows the current date. Consequently, device 201 can check whether regulation database system 203 has a record for Great Britain that is valid on that date. If so, device 201 can retrieve the proper mapping from regulation database system 203 and apply the DVB CPCM usage state that corresponds to the FTA/CTA signalling received in transport stream 251 to the content obtained at the DVB CPCM acquisition point. If, however, there is no record for Great Britain that is valid for that date, the receiver device module 209 does not pass the content to content protection module 217 but instructs device 201 to treat it as unprotected content corresponding to other device functions 219. Eventually, when such a regulation becomes activated in Great Britain, receiver device module 209 will retrieve the correct mapping from the regulation database system 203 and apply the resulting usage state to the content when sending it to the DVB CPCM acquisition point. If the owner travels to another country e.g., France, the same check is repeated. The other country, in this example, France may have slightly different regulations, and thus the mapping will be different. However, the correct usage state is retrieved from regulation database system 203 prior to sending the content to the DVB CPCM Acquisition Point.

Regulation database system 203 may also indicate whether regulatory information applies only to devices sold in that country within a certain time period instead of all devices currently being used in that country. If so, the country information and date sold may be configured at the point of sale. In such a case, device 201 memorizes the country in which it was when it was first turned on and the date. This capability allows device 201 to obey the regulations at the time of sale instead of the current regulations.

The records in regulation database system 203 may be replicated with different mappings to other content protection systems. Alternatively, there may be different databases for each different content protection system.

Because regulation database system 203 may be a target for hackers who intend to disable content protection, architecture 200 provides the security used for accessing database 203 as well as the integrity protection of database 203 itself.

Embodiments of the invention support receiver device 201 that connects to regulation database system 203 through the Internet or other suitable communications network, for example a mobile cellular network. Other embodiments may utilize country-tagging of the usage restrictions, in which broadcaster 205 recognizes the differences in the regulations of the different countries where the broadcast can be received, regardless of where broadcaster 205 is located.

A usage rule in CPCM is a particular operation upon or behavior of content to be controlled within the scope of the CPCM system. A complete set of usage rules assertions for a particular CPCM content item is referred to as the authorized usage of that CPCM content item. A content item's authorized usage is expressed by its coding in the usage state information (USI), which is CPCM content metadata that signals the authorized usage for the content. For example, Digital Video Broadcasting Content Protection & Copy Management (DVB-CPCM) DVB Document A094 Rev. 1, July 2007 provides semantics for usage state information. When content first enters the DVB CPCM system at the acquisition point, authorized usage of the content is determined and then preserved by securely binding it as USI metadata to the content. A content item's usage state information may implicitly or explicitly inhibit one or more of the abstract functions on the content item. With the usage rules as provided by said Digital Video Broadcasting Content Protection & Copy Management Document A094, usage rules may be divided into groups as follows:
Copy and Movement Control: CPCM instances are required to implement the controls required to enable content usage scenarios related to the Storage of Content Copies.
Consumption Control: There are two aspects to consumption control foreseen in the CPCM System: time-based usage or consumption of CPCM content and the ability to limit the number of concurrent consumption and export functions in operation for a CPCM content item.
Propagation Control: The CPCM reference model provides for usage rules to restrict the propagation of CPCM content inside the CPCM system to within certain realms.
Output Control: The output control usage rule provides the ability to enable, disable or constrain particular CPCM device outputs for particular types of CPCM content. The output control usage rule is applied to outputs used for consumption and export.
Ancillary Control: The CPCM system is required to provide a usage rule in which protection via the CPCM scrambler is not to be applied to content within the CPCM System.

Referring to copy and movement control, CPCM instances implement the controls required to enable content usage scenarios related to the storage of content copies, wherever applicable to the CPCM functionality implemented:
restriction on Copying (Copy Control Not Asserted) and corresponding to the Copy Control Not Asserted (CCNA) state.
Exactly one Copy is allowed to be made and maintained from the original content item (Copy Once) and corresponding to the Copy Once (C1) state. When a copy is created, no further Copies are allowed (corresponding to the Copy No More (CNM) state) except for a temporary buffer.
No Copies are allowed to be created (Copy Never), except for a secure temporary buffer, and corresponds to the Copy Never (CN) state. Copying is solely for the purpose of pausing of play-back, or trick-play. This buffer copy will not be accessible to the user, will not be maintained longer than is necessary to provide the pause or trick-play function, and cannot be saved.

Other states are defined for the other CPCM usage rules groups (Consumption Control, Propagation Control, Output Control, and Ancillary Control.) as specified in said Digital Video Broadcasting Content Protection & Copy Management Document A094.

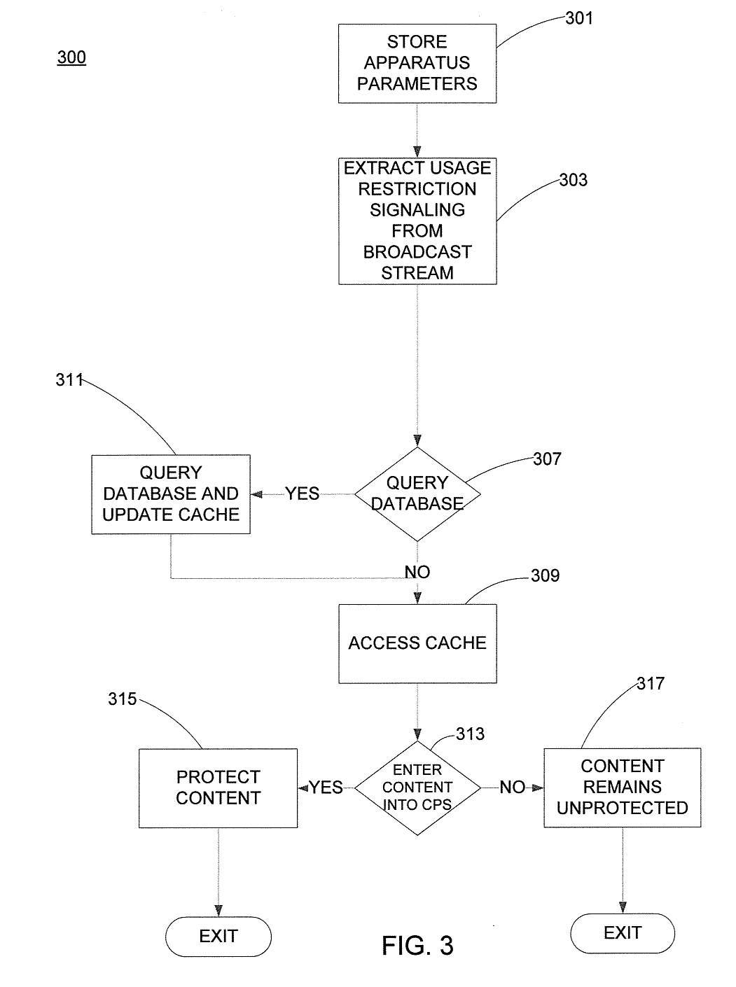

FIG. 3 shows flow diagram 300 for processing content received over a broadcast stream in accordance with an embodiment of the invention. In step 301, receiver device 201 determines and stores apparatus parameters for example the date and the current location of device 201 to determine whether received content is to be protected. In step 303, receiver device module 209 extracts usage restriction signaling from transport stream 251, wherein for example, usage restriction signaling may be contained in service information as previously discussed. In step 307, receiver device module 209 determines whether database system 203 needs to be queried or whether the regulations stored in cache memory 211 is sufficiently recent. In one embodiment the results of the queries may be cached in cache memory 211 for a predetermined period, e.g., a week or a month. If cache memory 211 needs to be updated, step 311 is executed. Receiver device module 209 obtains regulations pertaining to the country that receiver device 201 is currently located from cache memory 211 in step 309. As previously discussed, pertinent regulations may be based on the current date and on the country in which receiver device 201 is currently located or on the country that receiver device 201 was purchased or first turned on.

In step 313, receiver device module 209 determines whether the received content should be protected at the DVB CPCM acquisition point. The determination is based on the pertinent regulations based at least partly on the apparatus parameters and the extracted usage restriction signal. The regulatory information from database system 203 maps each of the signaling states to a corresponding DVB CPCM usage state as previously discussed. For example, if the determined usage state is the C1 (Copy Once) state, only one copy of the received content is permitted in the content protection system by step 315. However, if the determined usage state is the CCNA (Copy Control Not Asserted) state, the received content remains unprotected in step 317 i.e., redistribution is unrestricted in the content protection system.

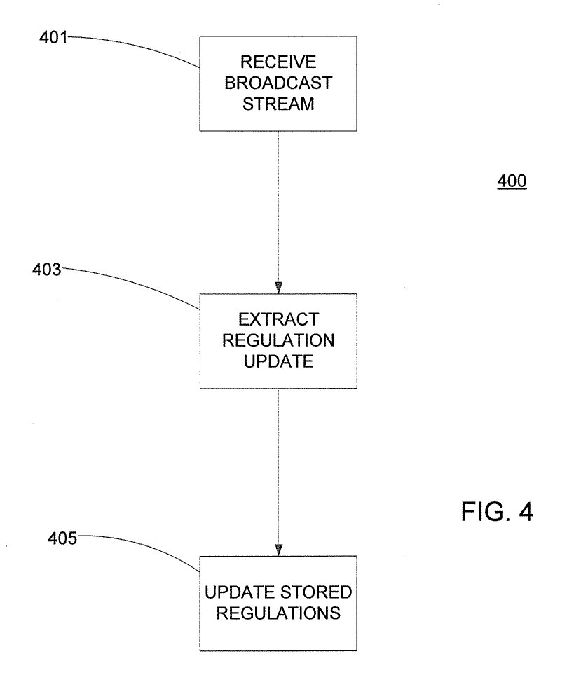

FIG. 4 shows process 400 for updating regulatory information when the regulatory information is sufficiently static in accordance with an embodiment of the invention. As previously discussed, in such a case, regulatory information may be locally stored in device 201 at the time of manufacture. Regulatory updates are pushed to receiver device 201 over the broadcast stream as received in step 401. In one embodiment, the regulation database updates are broadcast to the receiver devices using for example the DVB data carousel mechanism, which can also be used to deliver other software updates in the devices. The regulation database updates differ from the software updates in that they can be sent to a wide variety of different devices by different manufacturers in one go, instead of sending the same information separately to each kind of device. In step 403, receiver device module 209 extracts the regulatory updates and updates the stored memory in step 405.

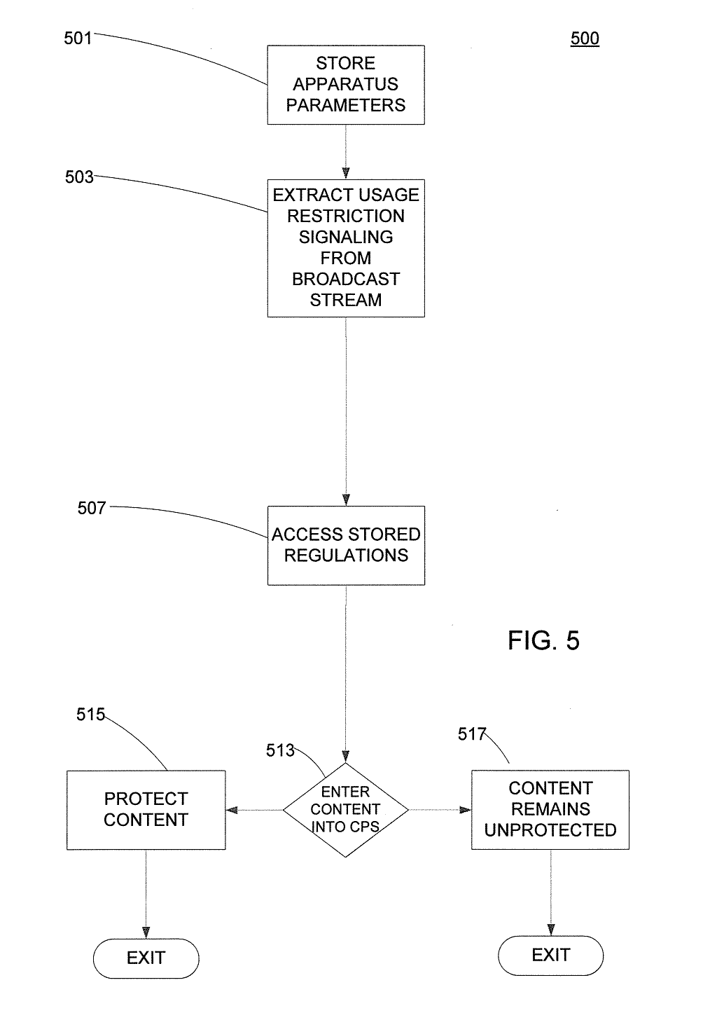

FIG. 5 shows flow diagram 500 for processing content received over a broadcast stream when regulatory information is updated in accordance with process 400 as shown in FIG. 4. Referring to FIG. 3, steps 501, 503, 513, 515, and 517 are similar to steps 301, 303, 313, 315, and 317, respectively, as previously discussed. However, regulations are accessed from stored memory in step 507 rather than directly accessing regulation database system 203. When regulations change, updates are pushed over the broadcast stream, and the stored memory is updated accordingly.

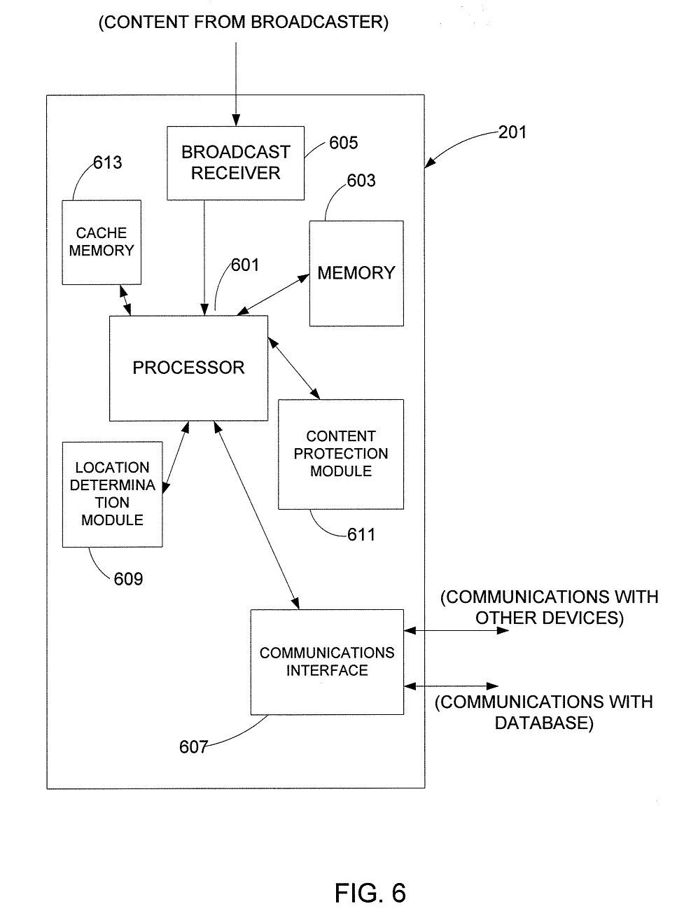

FIG. 6 shows an architecture of an apparatus, for example of the receiver device 201, that receives content from a broadcast stream in accordance with an embodiment of the invention. Broadcast receiver 605 receives a broadcast stream, and processor 601 extracts usage restriction signaling from the broadcast stream, for example transport stream 251.

Memory 603 contains computer-executable instructions that enable processor 601 to perform process 301 or 501 and to store data, e.g., apparatus parameters. Processor 601 queries regulation storage system 203 through communications interface 607 over a communications channel, for example via the Internet or other suitable communications network for example mobile cellular network. If regulations have been updated, cache memory 613 is updated. Processor 601 determines the usage state from the usage restriction signaling, the regulations obtained from cache memory 613, and current location obtained from location determination module 609. Content protection module 611 processes the received content in accordance with the usage state.

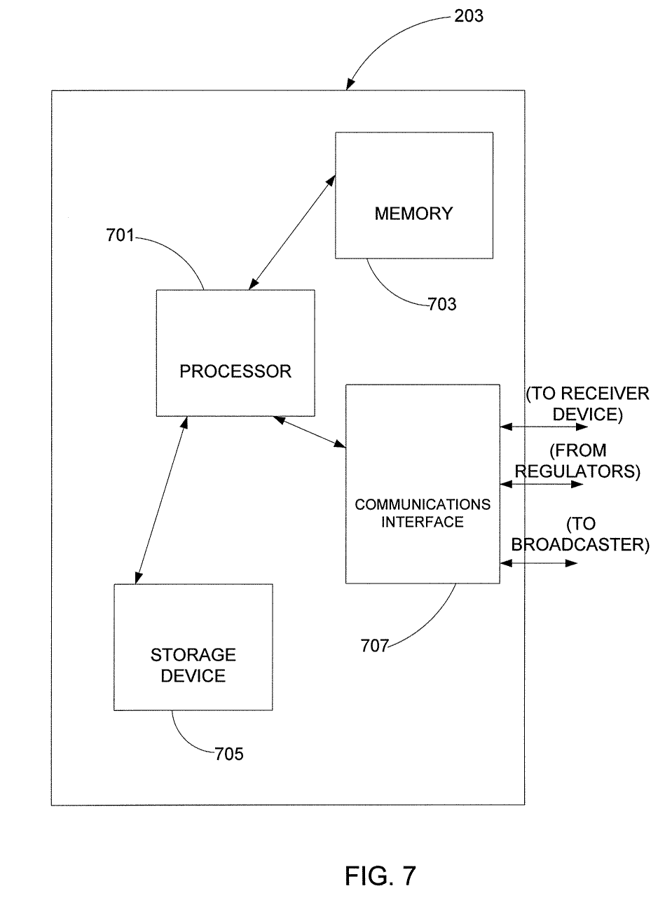

FIG. 7 shows an architecture of a storage system, for example regulation database system 203, that provides regulatory information in accordance with an embodiment of the invention. Storage device 705 contains updated regulations that are obtained from regulators and that may be accessed by receiver device 201 through communications interface 707. Rather than providing updated regulatory information to receiver device 201 as a response to a request, the storage system can push updates to receiver device 201 through interface 707 over the broadcast stream as previously discussed. Processor 701 executes computer-executable instructions from memory 703 in order to update the regulatory information from regulators, process queries from receiver device 201, and push updated regulatory information over the broadcast channel.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. An apparatus comprising:
a receiver circuit configured to obtain a broadcast stream;
a regulatory determination circuit configured to:
determine at least one apparatus parameter;
extract a usage restriction signal from the broadcast stream;
access regulatory information;
determine whether content extracted from the broadcast stream has to be protected based on the at least one apparatus parameter, the usage restriction signal, and the regulatory information;
applying a usage state to the content when the content is protected; and
a content protection circuit configured to provide protection of the content in accordance with the usage state and/or the regulatory information.

2. The apparatus of claim 1, further comprising:
a location determination circuit configured to determine a location of the apparatus, wherein the at least one apparatus parameter includes the location.

3. The apparatus of claim 1, further comprising:
a cache memory, wherein the regulatory determination circuit obtains regulatory updates from a remote database and stores the regulatory information in the cache memory.

4. The apparatus of claim 1, further comprising:
a storage device, wherein the regulatory determination circuit obtains regulatory updates from the broadcast stream and stores the regulatory updates in the storage device.

5. The apparatus of claim 1, wherein the content protection circuit provides digital video broadcasting (DVB) content protection and supports a copy management (CPCM) acquisition point.

6. The apparatus of claim 1, wherein the regulatory determination circuit extracts the usage restriction signal from service information in a digital video broadcasting (DVB) transmission.

7. A method comprising:
determining at least one apparatus parameter;
obtaining a broadcast stream from a transport stream;
extracting a usage restriction signal from the broadcast stream;
accessing regulatory information;
determining whether content extracted from the broadcast stream has to be protected based on the at least one apparatus parameter, the usage restriction signal, and the regulatory information;
applying a usage state to the content when the content is protected; and
protecting the content in accordance with the usage state and/or the regulatory information.

8. The method of claim 7, further comprising:
determining a location of an apparatus, wherein the at least one apparatus parameter includes the location.

9. The method of claim 7, further comprising:
obtaining regulatory updates; and
updating the regulatory information in accordance with the regulatory updates.

10. The method of claim 7, wherein the usage state is in accordance with digital video broadcasting (DVB) content protection and further comprising:
supporting a copy management (CPCM) acquisition point.

11. The method of claim 7, further comprising:
extracting the usage restriction signal from service information in a digital video broadcasting (DVB) transmission.

12. The method of claim 7, wherein access of the content is protected by at least one of conditional access (CA) and digital rights management (DRM).

13. The method of claim 8, wherein the location is based on a country where the apparatus is currently located.

14. The method of claim 8, wherein the location is based on a country where the apparatus was purchased.

15. The method of claim 8, wherein the location is based on a country where the apparatus was first turned on.

16. The method of claim 7, wherein the at least one apparatus parameter includes a current date.

17. The method of claim 7, wherein the usage restriction signal includes a country code to which a corresponding restriction applies.

18. A computer-readable medium having computer-executable instructions that when executed perform:
determining an apparatus parameter;
obtaining a broadcast stream from a transport stream;
extracting a usage restriction signal from the broadcast stream;
accessing regulatory information;
determining whether content extracted from the broadcast stream is protected based on the apparatus parameter, the usage restriction signal, and the regulatory information;
applying a usage state to the content when the content is protected; and
protecting the content in accordance with the usage state and/or the regulatory information.

19. The computer-readable medium of claim 18, wherein the instructions further perform:
determining a location of an apparatus, wherein the apparatus parameter includes the location.

20. The computer-readable medium of claim 18, wherein the instructions further perform:
obtaining regulatory updates; and
updating the regulatory information in accordance with the regulatory updates.

21. An apparatus comprising:
a storage device;
a communications interface; and
a processor configured to provide regulatory information from the storage device to a receiver device through the communications interface, wherein the regulatory information contains a mapping from each usage restriction signaling state to a corresponding usage state of a content protection system.

22. The apparatus of claim 21, wherein the processor is configured to receive updated regulatory information and to update the regulatory information that is stored in the storage device.

23. A method comprising:
mapping each usage restriction signaling state to a corresponding usage state of a content protection system to obtain regulatory information;
storing the regulatory information in a data structure; and
retrieving the regulatory information upon receiving a request.

24. The method of claim 23, further comprising:
receiving updated regulatory information; and
updating the regulatory information in the data structure with the updated regulatory information.

25. The method of claim 24, further comprising:
sending the updated regulatory information to a receiving device through a broadcast stream.

25. A computer-readable medium having computer-executable instructions that when executed perform:
mapping each usage restriction signaling state to a corresponding usage state of a content protection system to form regulatory information;
storing the regulatory information in a data structure; and
retrieving the regulatory information when receiving a request.

26. The computer-readable medium of claim 25, wherein the instructions further perform:
receiving updated regulatory information; and
updating the regulatory information in the data structure with the updated regulatory information.

27. The computer-readable medium of claim 26, wherein the instructions further perform:
sending the updated regulatory information to a receiving device through a broadcast stream.
